(19) United States
(12) Patent Application Publication
(10) Pub. No.: US 2010/0020459 A1
(43) Pub. Date: Jan. 28, 2010

(54) SURGE ARRESTER

(75) Inventor: THOMAS GÖSCHL, Hirschbach (AT)

Correspondence Address: HENRY M FEIEREISEN, LLC;HENRY M FEIEREISEN, 708 THIRD AVENUE, SUITE 1501, NEW YORK, NY, 10017, US

(73) Assignee: Moeller Gebaudeautomation GmbH, Schrems (AT)

(21) Appl. No.: 12/508,667

(22) Filed: Jul. 24, 2009

Related U.S. Application Data
(60) Provisional application No. 61/083,702, filed on Jul. 25, 2008.

(30) Foreign Application Priority Data
Jul. 25, 2008 (AT) A 1162/2008

(51) Int. Cl. H02H 9/04

(52) U.S. Cl. 361/117

(57) ABSTRACT

A surge arrester includes a device base, secured to a mounting rail and having a U-shaped receptacle, and at least one insert part having at least one surge voltage protection element and arranged in the receptacle of the device base. To provide a secure connection between the insert part and the device base, the insert part is locked in the receptacle by an arresting cap which is a component separate from the insert part and/or from the device base.

### CROSS-REFERENCES TO RELATED APPLICATIONS

This application claims the benefit of prior filed U.S. provisional Application No. 61/083,702, filed Jul. 25, 2008, pursuant to 35 U.S.C. 119(e), the content of which is incorporated herein by reference in its entirety as if fully set forth herein.

This application also claims the priority of Austrian Patent Application, Serial No. A 1162/2008, filed Jul. 25, 2008, pursuant to 35 U.S.C. 119(a)-(d).

### BACKGROUND OF THE INVENTION

The present invention relates to a surge arrester.

The following discussion of related art is provided to assist the reader in understanding the advantages of the invention, and is not to be construed as an admission that this related art is prior art to this invention.

Surge arresters can be used as insertable device combination comprised of a bottom part or device base and a plug-in module or insert. The device base includes terminals for making contact with the electric leads and a receptacle to accommodate the insert part to be inserted, whereas at least one surge voltage protection element is arranged in the insert part. The electric connection between the insert part and the device base usually occurs by means of plug contacts. Due to such a modular arrangement, the actual surge voltage protection element can simply be checked by removing it from the electric circuit. As a result of the modular arrangement, the surge voltage protection element can be removed from the electric circuit without a need to remove the entire surge arrester from the electrical installation. The drawback, however, is that the insert part can be moved out of the device base by high electrodynamic forces which occur during a lightning phenomenon for example. The respective connection between the insert part and the device base is therefore often arranged in such a way that the application of tools is required for connecting or disconnecting the insert part and the device base.

Surge arresters are produced for different customers and markets with different housing configurations. The housings of modern switching devices are usually produced as injection-molded parts made of plastic. This is disadvantageous because the tools for injection-molding machines are very complex and thus expensive, so that the production of different housings for different markets incurs considerable additional production costs. Moreover, the resultant great number of different switching devices lead to costly warehousing, thus making it difficult to respond to changed market requirements.

It would therefore be desirable and advantageous to provide an improved surge arrester to obviate prior art shortcomings and to realize a secure connection between insert part and device base without the need for tools and to reduce warehousing or production costs.

### SUMMARY OF THE INVENTION

According to one aspect of the present invention, a surge arrester includes a device base constructed for securement to a mounting rail and having a U-shaped receptacle, at least one insert part received in the receptacle of the device base and having at least one surge voltage protection element, and an arresting cap to lock the insert part in the receptacle, said arresting cap representing a component separate from the insert part and/or the device base.

The present invention resolves prior art problems by providing an arresting cap which firmly connects the insert part with the device base and is able to withstand high electrodynamic forces that occur during a lightning phenomenon. This ensures a simple insertion and connection of the insert part with the device base without the need for any tools and the insert part can easily be removed from the device base. Surge arresters can thus be arranged for different customers and different markets in an electrotechnically identical manner, thus requiring a lower number of production tools. The production expenditure and the expenditure for warehousing can be reduced by using the arresting cap. As a result, it is possible to respond within a short period to changed orders because a surge arrester can be adjusted to the design requirements of a customer and market merely by matching arresting caps.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows an axonometric view of one embodiment of a surge arrester in accordance with the present invention;

FIG. 2 shows an axonometric exploded view of individual components of the surge arrester of FIG. 1;

FIG. 3 shows an axonometric view of a housing half of a device base and an insert part, and an arresting cap of the surge arrester of FIG. 1; and

FIG. 4 shows an enlarged view in vertical projection of a detail of the surge arrester of FIG. 3.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

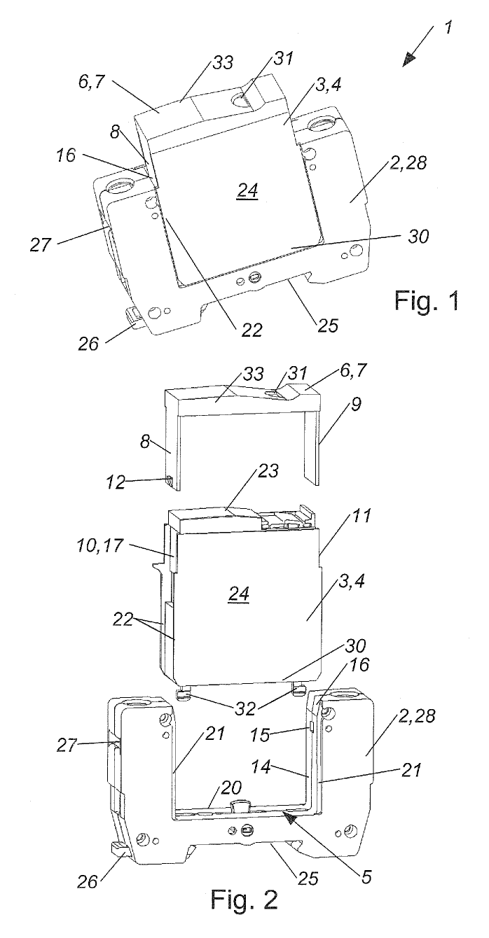

Turning now to the drawing, and in particular to FIG. 1, there is shown an axonometric view of one embodiment of a surge arrester in accordance with the present invention, generally designated by reference numeral 1. The surge arrester 1 includes a device base 2 and at least one insert part 3, with the device base 2 being provided for securement to a mounting rail. The insert part 3 has at least one surge voltage protection element and a partial insert housing 4 and is arranged in a U-shaped receptacle 5 of the device base 2. An arresting cap 6 locks the insert part 3 in the U-shaped receptacle 5 and represents a component separate from the insert part 3 and/or from the device base 2.

A secure connection of the insert part 3 with the device base 2 can thus be achieved which also withstands the high electrodynamic forces which occur during a lightning phenomenon. This enables a simple insertion and connection of the insert part 3 with the device base 2 without the need for any tools. This enables also a simple removal of the insert part 3 from the device base 2. Surge arresters 1 can thus be arranged for different customers and different markets in an electrotechnically identical manner, thus requiring a lower number of production tools and requiring only one single technical acceptance of the surge arrester 1. The production expenditure and the expenditure for warehousing can be reduced by using the arresting cap 6. As a result, it is possible to respond within a short period to changed orders because a surge arrester 1 can be adjusted to the design requirements of a customer and market merely by matching arresting caps 6.

A surge arrester 1 in accordance with the invention can be used for the protection of electric installations and/or humans from electric surge voltages which propagate on an electric line. Especially the sensitivity and the importance of computers have led to a large dissemination of surge arresters 1. The surge arrester 1 is usually arranged as a component which, under mains voltage, produces a highly resistive or insulating connection between at least one phase and an external conductor of an electric network, especially an electric power supply network, and a neutral conductor or a further phase of the network. If no surge voltage occurs, virtually no current flows through the surge arrester 1, and the function of the subsequent network is not influenced by the presence of the surge arrester 1. When a surge voltage occurs, the surge arrester 1 forms a very low-resistance junction between phase and neutral conductor or a further phase, and thus bridges the subsequent network. The surge arrester 1 comprises for this purpose at least one surge voltage protection element, which is preferably arranged as a varistor, surge voltage protection diode, gas-discharge arrester or the like.

The surge arrester 1 in accordance with the present invention has a modular configuration comprised of a device base 2, an insert part 3, and an arresting cap 6.

The device base 2 is provided for arrangement on a mounting rail such as top-hat rails and comprises for this purpose a respective mounting rail receptacle 25 and the necessary mounting means 26. In order to connect to the electric network to be protected, the device base 2 comprises at least one first and one second terminal 27. FIG. 1 shows a surge arrester 1 with merely two terminals 27 for the protection of a single-phase electric network. Of course the surge arrester 1 may also be configured for the protection of multi-phase networks and thus may have a greater number of terminals 27.

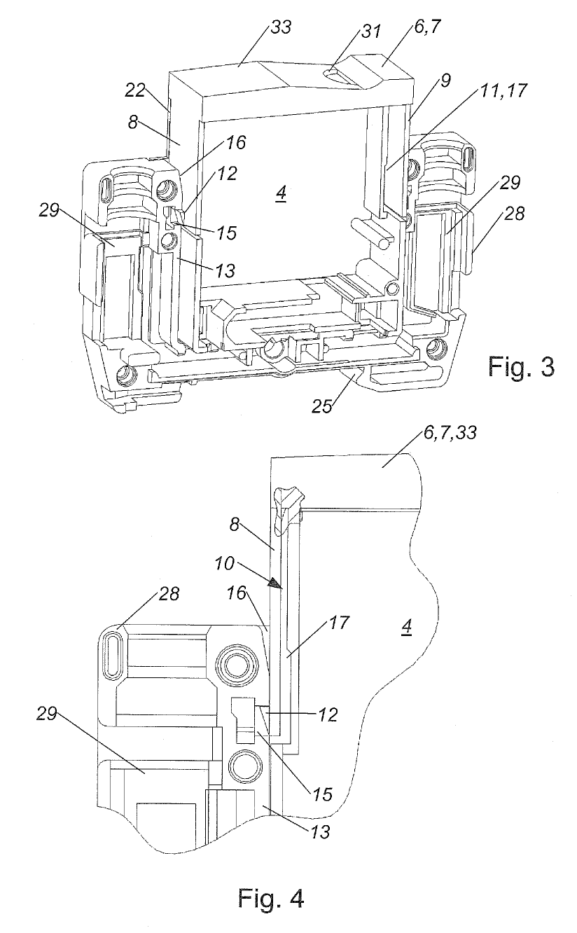

The device base 2 includes a two-part housing 28 which is shown in FIGS. 1 to 4 and made of an insulating material. FIG. 3 shows i.a. a half shell of a housing 28. The receptacles 29 for the two terminals (not shown) are also shown.

The device base 2 comprises a substantially U-shaped receptacle 5 for receiving the insert part 3. The U-shaped receptacle 5 comprises first and second side parts 13, 14 and a base part 20 which connects the side parts 13, 14. The receptacle 5 is arranged in a diametrically opposed manner in relation to a bottom part 30 of the insert part 3 which is provided to be inserted in the U-shaped receptacle 5. The U-shaped receptacle 5 comprises inner contacts (also not shown) for making contact with the insert part 3, preferably in the region of the base part 20. In order to simplify the insertion of insert part 3 in the U-shaped receptacle 5, one insertion region 16 each is arranged on the first and/or second side part 13, 14.

The insert part 3 has an insert housing 4 which is made of an insulating material which is preferably made of several parts. The insert housing 4 encloses the insert part 3 in a substantially complete manner and on all sides, with merely the regions for making contact with the device base 2 and for display means being arranged to be free of the insert housing. The insert part 3 is arranged as a component that is fully functional from an electrotechnical standpoint even without the arresting cap 6 in accordance with the invention, and can therefore be tested and accepted in an electrotechnical way as such. The insert housing 4 encloses the insert part 3 in such a way that no inner modules are accessible from the outside. The insert part 3 further comprises electric contact pins 32 which protrude from the insert housing 4 in order to make contact with the inner contacts of the device base 2.

It is provided in accordance with the invention that the insert part 3 is locked by an arresting cap 6 in the U-shaped receptacle 5 and the arresting cap 6 is arranged to be separate from the insert part 3 and/or the device base 2. The device base 2 has a housing 28 and the insert part 3 has an insert housing 4. Both the device base 2 and the insert part 3 are already finished electric devices even without the arresting cap 6. The feature that the arresting cap 6 is arranged to be separate from the insert part 3 and/or the device base 2 is illustrated by the fact that the arresting cap 6 is neither a part of the device base housing 28 nor the insert housing 4, but that it is an additional component which is independent from these.

The arresting cap 6 is preferably made of an insulating material, especially of a plastic material which can be processed by means of injection molding, and can have any shape that is suitable for locking the insert part 3 in the device base 2. Advantageously, the arresting cap 6 is constructed to lock the insert part 3 in the device base 2 without the application of tools such as bayonet catches, screws with wing nuts, or latching connections. Suitably, the arresting cap 6 is connected to the device base 2 by means of a latching connection.

The arresting cap 6 can be configured to best suit the cooperation with the insert part 3 and a device base 2. According to a preferred embodiment of an insert part 3 and a device base 2 in which the insert part 3 protrudes beyond the device base 2 in the case of an arrangement in the U-shaped receptacle 5 of the device base 2, it is provided that the arresting cap 6 is arranged as a U-shaped clamp 7 comprising first and second legs 8, 9 in surrounding relationship to the insert part 3 in first and second regions 10, 11, respectively. By encompassing the insert part 3, it is secured permanently against removal from the device base 2, and especially a so-called levering of the insert part 3 can be prevented. The arresting cap 6 comprises a middle part 33 on which the first and second legs 8, 9 are formed. The middle part 33 is preferably arranged in such a way that the same encompasses the insert part 3 on five areas at least in sections. Advantageously, the middle part 33 is arranged in the manner of a trough, and encompasses an upper side 23 of the insert part which is averted from the base part 20 of the U-shaped receptacle 5 and the regions of the side surfaces 24 of the insert part 3 which are directly adjacent to said upper side 23. This helps achieve an especially good hold of the arresting cap 6. The insert part 3 can thus also be secured against lateral loading states. The middle part 33 further preferably comprises a breakthrough 31 in order to show a display of the insert part 3 to the user.

The first leg 8 and the second leg 9 are preferably arranged in a resilient manner, and each comprises at least one latching nose 12 which is arranged to face the U-shaped receptacle. The latching noses are arranged as a flat wedge according to the preferred embodiment. It can also be provided that several latching noses 12 are provided, e.g. in the form of several latching noses 12 arranged next to one another or on top of one another. At least one latching opening 15 each is arranged on the first and/or the second side part 13, 14 for engagement of the latching noses 12, with the latching openings 15 being arranged to be diametrically opposite to the latching noses 12 in order to ensure secure latching of the latching noses 12. In order to enable simple removal of the arresting cap 6 and further the insert part 3 from the device base 2, the insert housing 4 comprises an undercut 17 each in the first and second region 10, 11. The first and second regions 10, 11 of the insert part are regions between the upper side 23 of the insert part 3 and the latching openings 15 of the device base 2, when the insert part 3 is arranged in the U-shaped receptacle 6.

Advantageously, the U-shaped receptacle 5, preferably the first and second legs 8, 9, comprises at least one guide 21 which has a progression along the direction of insertion of the insert part 3 in the U-shaped receptacle 5. For this purpose it is preferably further provided that the insert part 3 comprises at least one projection 22 for engagement in the guide 21 of the U-shaped receptacle 5. This helps achieve a secure guidance of the insert part 3 in the insertion into the U-shaped recess 5. At the same time, the insert part 3 is protected against lateral removal thereby. The guide means 21 is preferably arranged as a groove or step, as is shown in FIGS. 2 and 3 for example. The insert part 3 further comprises side surfaces 24 which are preferably plane-parallel and which are arranged that they protrude laterally beyond the arresting cap 6, when the arresting cap 6 is arranged on the insert part 3, and thus forms the preferably rail-like projection 22.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A surge arrester, comprising:
a device base constructed for securement to a mounting rail and having a U-shaped receptacle;
at least one insert part received in the receptacle of the device base and having at least one surge voltage protection element; and
an arresting cap to lock the insert part in the receptacle, said arresting cap representing a component separate from the insert part and/or the device base.

2. The surge arrester of claim 1, wherein the arresting cap is connected to the device base by a latching connection.

3. The surge arrester of claim 1, wherein the arresting cap is configured in the form of a U-shaped clamp having first and second legs in surrounding relationship to first and second regions of the insert part.

4. The surge arrester of claim 3, wherein each of the first and second legs has a resilient configuration and is provided with at least one latching nose.

5. The surge arrester of claim 4, wherein the receptacle has first and second side parts, each provided with at least one latching opening for engagement of the latching noses of the first and second legs.

6. The surge arrester of claim 5, wherein at least one of the first and second side parts of the receptacle is configured with an insertion region.

7. The surge arrester of claim 1, wherein the insert part has a housing for accommodating the surge voltage protection element, said housing having first and second regions, each formed with an undercut.

8. The surge arrester of claim 1, wherein the receptacle has a guide for guiding the insert part.

9. The surge arrester of claim 3, wherein the first and second legs have a guide guidance of the clamp upon the insert part.

10. The surge arrester of claim 8, wherein the insert part comprises a projection for engagement in the guide of the receptacle.
